(19) United States
(12) Patent Application Publication
(10) Pub. No.: US 2020/0298605 A1
(43) Pub. Date: Sep. 24, 2020

(54) IMAGE FORMING APPARATUS AND IMAGE FORMING METHOD

(71) Applicant: Konica Minolta, Inc., Tokyo (JP)

(72) Inventors: Kazuko FUKUMOTO, Osaka (JP); Eiji TABATA, Osaka (JP); Makiko WATANABE, Uji-shi (JP)

(21) Appl. No.: 16/774,500

(22) Filed: Jan. 28, 2020

(30) Foreign Application Priority Data
Mar. 22, 2019 (JP) 2019-054626

(51) Int. Cl. B41M 5/00; B41J 11/00

(52) U.S. Cl. CPC B41M 5/0017; B41J 11/002

(57) ABSTRACT

An image forming apparatus includes a precoating layer forming unit that forms a precoating layer on a surface of a recording medium, an image forming unit that forms an image on the precoating layer with ink, and a light energy emitter that emits light energy for drying the ink to the recording medium. The precoating layer contains a reflective agent that reflects light energy.

The entire disclosure of Japanese Patent Application No. 2019-054626 filed on Mar. 22, 2019 is incorporated herein by reference in its entirety.

### BACKGROUND

### Technological Field

The present invention relates to an image forming apparatus and an image forming method.

### Description of the Related Art

An ink jet printing technique has conventionally been known. For example, Japanese Laid-Open Patent Publication No. 2016-65137 discloses an image recording apparatus (an image forming apparatus) including treatment liquid discharge means for discharging a treatment liquid by an ink-jet method onto a recording medium such as a resin film, ink discharge means for discharging ink for ink-jet recording onto the recording medium, and emission means for emitting infrared rays to the treatment liquid attached to the recording medium. The treatment liquid discharged by the treatment liquid discharge means contains an infrared ray absorbent. The ink discharge means discharges from an ink-jet head, droplets of ink onto the recording medium onto which the treatment liquid has been discharged. The emission means emits infrared rays to the treatment liquid attached to the recording medium. The emission means emits infrared rays until ink is dried. In the image recording apparatus, the treatment liquid contains the infrared ray absorbent and therefore a speed of drying of ink is improved.

### SUMMARY

In the image forming apparatus described in Japanese Laid-Open Patent Publication No. 2016-65137, the treatment liquid contains the infrared ray absorbent. Therefore, when infrared rays are emitted, a temperature of the recording medium becomes high and the recording medium may deform. This is particularly noticeable when a resin film is employed as the recording medium.

Since a time period for drying ink is different depending on a thickness or a material of the recording medium, efforts for finding preferred drying conditions for each recording medium within a range not causing deformation of the recording medium and efforts for changing setting of the drying conditions in accordance with a thickness or a type of the recording medium become complicated.

An object of the present invention is to provide an image forming apparatus and an image forming method that can achieve both of suppression of deformation of a recording medium and lowering in frequency of change of setting of a condition for drying ink.

To achieve at least one of the abovementioned objects, according to an aspect of the present invention, an image forming apparatus reflecting one aspect of the present invention comprises a precoating layer forming unit that forms a precoating layer on a surface of a recording medium, an image forming unit that forms an image on the precoating layer with ink, and a light energy emitter that emits light energy for drying the ink to the recording medium. The precoating layer contains a reflective agent that reflects light energy.

To achieve at least one of the abovementioned objects, according to an aspect of the present invention, an image forming method reflecting one aspect of the present invention comprises applying an aqueous solution that forms a precoating layer to a surface of a recording medium, forming the precoating layer by drying the aqueous solution, forming an image by supplying ink onto the precoating layer, and emitting light energy for drying the ink to the recording medium. The aqueous solution applied in the applying an aqueous solution contains a reflective agent that reflects the light energy.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram schematically showing an overall configuration of an image forming apparatus in one embodiment of the present invention.

FIG. 2 is a diagram schematically showing a construction of a precoating layer.

### DETAILED DESCRIPTION OF EMBODIMENTS

Hereinafter, one or more embodiments of the present invention will be described with reference to the drawings. However, the scope of the invention is not limited to the disclosed embodiments. Identical or corresponding members in the drawings referred to below have the same reference numerals allotted.

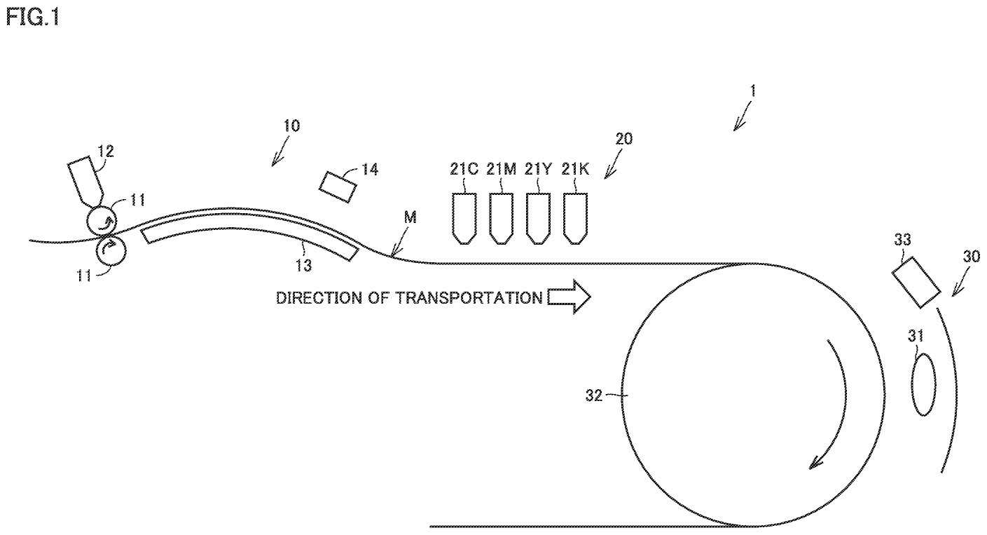

FIG. 1 is a diagram schematically showing an overall configuration of an image forming apparatus in one embodiment of the present invention. For example, an ink-jet printer is employed as this image forming apparatus 1.

As shown in FIG. 1, image forming apparatus 1 includes a precoating layer forming unit 10, an image forming unit 20, and an ink dryer 30.

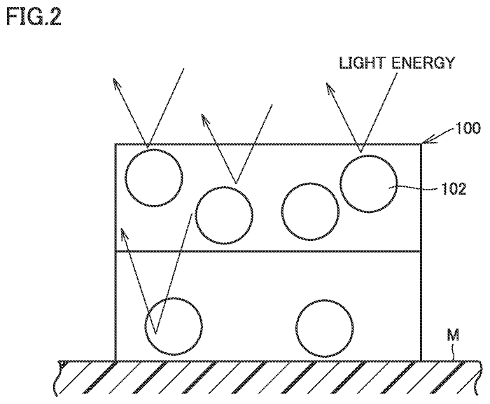

Precoating layer forming unit 10 forms a precoating layer 100 (see FIG. 2) on a surface of a recording medium M. Precoating layer 100 is provided for suppressing rejection or smear of water-based ink on recording medium M. Precoating layer forming unit 10 includes a pair of transportation rollers 11, an aqueous solution supply unit 12, a heater 13, and a warm air blower 14.

The pair of transportation rollers 11 transports recording medium M. Examples of recording medium M include a resin film (for example, a PET film, a PP film, and a PE film) and plain paper.

Aqueous solution supply unit 12 supplies an aqueous solution to transportation roller 11 in contact with a print surface of recording medium M, of the pair of transportation rollers 11. Therefore, the aqueous solution is supplied to the print surface of recording medium M. Transportation roller 11 and aqueous solution supply unit 12 perform a step of applying the aqueous solution that forms precoating layer 100 to the surface of recording medium M.

The aqueous solution contains a resin material, a surfactant, and a reflective agent. Examples of the resin material include a urethane resin, an acrylic resin, a mixture thereof, and urethane olefin.

The reflective agent reflects infrared rays or ultraviolet rays. Examples of an infrared ray reflective agent that reflects infrared rays and an ultraviolet ray reflective agent that reflects ultraviolet rays include titanium oxide (TiO₂), zinc oxide, white lead, and zinc sulfide. The reflective agent is preferably transparent. In order to secure transparency of the reflective agent, the reflective agent has a particle size preferably not greater than 100 nm. Examples of the infrared ray reflective agent having transparency include titanium oxide having a particle size from 50 nm to 100 nm and silver nanoparticles in a shape of a flat plate having a particle size of approximately 100 nm.

The aqueous solution may contain hollow particles. In this case, low refraction is expected.

Heater 13 is arranged below recording medium M. Heater 13 heats recording medium M from a side of a rear surface (a surface opposite to the print surface) of recording medium M.

Warm air blower 14 is arranged above recording medium M. Warm air blower 14 blows warm air toward the print surface of recording medium M.

The aqueous solution supplied to the print surface of recording medium M becomes precoating layer 100 by being heated by heater 13 and warm air blower 14. In other words, heater 13 and warm air blower 14 perform a step of forming precoating layer 100 by drying the aqueous solution. FIG. 2 is a diagram schematically showing a construction of the precoating layer. Precoating layer 100 has a thickness preferably greater than a particle size of a reflective agent 102. For example, precoating layer 100 has a thickness preferably not smaller than 0.1 μm and more preferably not smaller than 0.2 μm. From a point of view of suppression of consumption of energy used for drying the aqueous solution, precoating layer 100 has a thickness preferably not greater than 0.5 μm.

Image forming unit 20 is provided downstream from precoating layer forming unit 10 in a direction of transportation of recording medium M. Image forming unit 20 forms an image on precoating layer 100 with ink. In other words, image forming unit 20 performs a step of forming an image by supplying ink onto precoating layer 100. Image forming unit 20 in the present embodiment is of a water-based ink jet type. Image forming unit 20 includes a first discharge head 21C, a second discharge head 21M, a third discharge head 21Y, and a fourth discharge head 21K. Each of discharge heads 21C, 21M, 21Y, and 21K supplies ink of each of cyan (C), magenta (M), yellow (Y), and black (K) onto precoating layer 100.

Ink dryer 30 is provided downstream from image forming unit 20 in the direction of transportation of recording medium M. Ink dryer 30 dries ink (water-based ink) supplied onto precoating layer 100. Ink dryer 30 includes a light energy emitter 31, a heat drum 32, and a warm air blower 33.

Light energy emitter 31 emits to recording medium M, light energy for drying ink supplied onto precoating layer 100. In other words, light energy emitter 31 performs a step of emitting light energy for drying ink to recording medium M. Light energy emitter 31 is arranged above recording medium M. Light energy emitter 31 emits infrared rays as light energy when an infrared ray reflective agent is employed as reflective agent 102. Light energy emitter 31 emits ultraviolet rays as light energy when an ultraviolet ray reflective agent is employed as reflective agent 102. An infrared heater or an ultraviolet heater is preferably employed as light energy emitter 31.

Heat drum 32 heats recording medium M from the side of the rear surface of recording medium M and transports recording medium M.

Warm air blower 33 is arranged above recording medium M. Warm air blower 33 blows warm air toward the print surface of recording medium M.

As described above, in image forming apparatus 1 in the present embodiment, precoating layer 100 contains reflective agent 102 that reflects light energy. Therefore, absorption of light energy in precoating layer 100 is suppressed. Since significant increase in temperature of recording medium M during or after emission of light energy is thus suppressed, deformation of recording medium M is suppressed. Since a drying condition for not causing deformation of recording medium M is thus relaxed, a frequency of change of setting of the condition for drying ink can be lowered.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

For example, precoating layer 100 may be constituted of a plurality of protective layers. In this case, light energy may be reflected by making indices of refraction of the protective layers different from one another. When precoating layer 100 is constituted of two layers, a first protective layer may be formed prior to the step performed by precoating layer forming unit 10, and a second protective layer may be formed by precoating layer forming unit 10.

The image forming apparatus and the image forming method described above and effects achieved by the image forming apparatus and the image forming method will briefly be described.

An image forming apparatus includes a precoating layer forming unit that forms a precoating layer on a surface of a recording medium, an image forming unit that forms an image on the precoating layer with ink, and a light energy emitter that emits light energy for drying ink to the recording medium. The precoating layer contains a reflective agent that reflects light energy.

In the image forming apparatus, since the precoating layer contains the reflective agent that reflects light energy, absorption of light energy in the precoating layer is suppressed. Since significant increase in temperature of the recording medium during or after emission of light energy is thus suppressed, deformation of the recording medium is suppressed. Since a drying condition for not causing deformation of the recording medium is thus relaxed, a frequency of change of setting of the condition for drying ink can be lowered.

For example, the light energy emitter may emit infrared rays as light energy and the precoating layer forming unit may form the precoating layer containing an infrared ray reflective agent as the reflective agent.

Alternatively, the light energy emitter may emit ultraviolet rays as light energy and the precoating layer forming unit may form the precoating layer containing an ultraviolet ray reflective agent as the reflective agent.

The precoating layer preferably contains a urethane resin or an acrylic resin.

An image forming method includes applying an aqueous solution that forms a precoating layer to a surface of a recording medium, forming the precoating layer by drying the aqueous solution, forming an image by supplying ink onto the precoating layer, and emitting light energy for drying ink to the recording medium. The aqueous solution applied in the applying an aqueous solution contains a reflective agent that reflects light energy.

With the image forming method, deformation of the recording medium is suppressed and a frequency of change of setting of a condition for drying ink can be lowered.

### EXAMPLES

Examples of the embodiment will now be described together with Comparative Examples.

### Example 1

In Example 1, a PET film having a thickness of 50 μm was employed as recording medium M. Since a PET film, a PP film, and a PE film reject a water-based liquid, precoating layer 100 should be formed thereon.

An aqueous solution containing 25 weight % of a urethane resin, 1 weight % of a surfactant, and 10 weight % of titanium oxide as reflective agent 102 having a particle size not greater than 100 nm was employed as the aqueous solution to be supplied from aqueous solution supply unit 12. A temperature of heater 13 was set to 70° C. and a time period for drying by warm air blower 14 at a speed of 30 m/min. was set to 10 seconds such that a temperature of an atmosphere in the drying step was set to 70° C. Consequently, precoating layer 100 had a thickness of 0.6 μm.

Then, an image was printed by image forming unit 20 on precoating layer 100 with water-based ink containing 20 weight % of an ethylene glycol moisture retaining agent, 1 weight % of a nonionic surfactant, and 5 weight % of a pigment (copper phthalocyanine). Water-based ink is temporarily fixed to a surface layer of precoating layer 100 as soon as it reaches precoating layer 100, which permits blow of warm air to water-based ink.

Infrared rays having a peak wavelength of 1250 nm were emitted from light energy emitter 31 to recording medium M, a temperature of heat drum 32 was maintained at 70° C., a rotation speed of heat drum 32 was set to 30 m/min., warm air at 7 m/s was blown from warm air blower 33, and a time period for drying was set to 10 seconds.

After passage through ink dryer 30, a temperature of the rear surface (a surface where no image was formed) of recording medium M was measured with a temperature sensor and the temperature was found as 85° C. The image was dry and deformation of recording medium M was not observed.

### Example 2

In Example 2, a PET film having a thickness of 10 μm was employed as recording medium M. Other conditions were the same as in Example 1. A temperature of the rear surface of recording medium M after passage through ink dryer 30 was 88° C. In Example 2 again, the image was dry and deformation of recording medium M was not observed.

### Comparative Example 1

Conditions were the same as in Example 1 except that the aqueous solution did not contain reflective agent (titanium oxide) 102 and recording medium M had a thickness of 10 μm. In Comparative Example 1, after passage through ink dryer 30, the image was dry, whereas the temperature of recording medium M was 130° C. and deformation of recording medium M was observed.

### Comparative Example 2

Conditions were the same as in Comparative Example 1 except that recording medium M had a thickness of 50 μm. In Comparative Example 2, after passage through ink dryer 30, the image was dry, whereas the temperature of recording medium M was 110° C. and deformation of recording medium M was observed.

As set forth above, it was confirmed that, in Comparative Examples, setting of a drying condition should be changed depending on a thickness or a type of recording medium M in order to avoid deformation of recording medium M after passage through ink dryer 30, whereas, by forming precoating layer 100 containing reflective agent 102 as in Examples, both of drying of ink and suppression of deformation of recording medium M were achieved without changing a condition for drying ink regardless of a thickness of recording medium M.

Although embodiments of the present invention have been described and illustrated in detail, the disclosed embodiments are made for the purposes of illustration and example only and not limitation. The scope of the present invention irradiated be interpreted by terms of the appended claims.

What is claimed is:

1. An image forming apparatus comprising:
a precoating layer forming unit that forms a precoating layer on a surface of a recording medium;
an image forming unit that forms an image on the precoating layer with ink; and
a light energy emitter that emits light energy for drying the ink to the recording medium,
the precoating layer containing a reflective agent that reflects the light energy.

2. The image forming apparatus according to claim 1, wherein
the light energy emitter emits infrared rays as the light energy, and
the precoating layer forming unit forms the precoating layer containing an infrared ray reflective agent as the reflective agent.

3. The image forming apparatus according to claim 1, wherein
the light energy emitter emits ultraviolet rays as the light energy, and
the precoating layer forming unit forms the precoating layer containing an ultraviolet ray reflective agent as the reflective agent.

4. The image forming apparatus according to claim 1, wherein
the precoating layer contains a urethane resin or an acrylic resin.

5. An image forming method comprising:
applying an aqueous solution that forms a precoating layer to a surface of a recording medium;
forming the precoating layer by drying the aqueous solution;
forming an image by supplying ink onto the precoating layer; and
emitting light energy for drying the ink to the recording medium,
the aqueous solution applied in the applying an aqueous solution containing a reflective agent that reflects the light energy.
